(19) United States
(12) Patent Application Publication
(10) Pub. No.: US 2023/0193861 A1
(43) Pub. Date: Jun. 22, 2023

(54) EGR VALVE SYSTEM

(71) Applicant: AISAN KOGYO KABUSHIKI KAISHA, Obu-shi, Aichi-ken (JP)

(72) Inventor: Koichi SUGIHARA, Chiryu-shi (JP)

(73) Assignee: AISAN KOGYO KABUSHIKI KAISHA, Obu-shi, Aichi-ken (JP)

(21) Appl. No.: 17/768,339

(22) PCT Filed: Oct. 9, 2020
(86) PCT No.: PCT/JP2020/038230

§ 371 Date: Apr. 12, 2022

(30) Foreign Application Priority Data
Nov. 1, 2019 (JP) 2019-199730

(51) Int. Cl. F02M 26/72; F02M 26/54; F02M 26/68; F16K 27/02

(52) U.S. Cl. CPC F02M 26/72; F02M 26/54; F02M 26/68; F16K 27/029

(57) ABSTRACT

This EGR valve system is provided with a valve assembly, and a plurality of housing adapters. The valve assembly is provided with a housing including a flow passage, a valve seat provided in the flow passage, a valve element provided in the flow passage in such a way as to be capable of seating against the valve seat, a valve shaft on which the valve element is provided, and a driving unit for driving the valve shaft. The housing adapters include assembly holes, inlet flow passages which communicate with the assembly holes, and outlet flow passages. One of the housing adapters is selectively combined with the valve assembly, the housing of the valve assembly is assembled in the assembly hole of the selected housing adapter. In this assembled state, the inlet flow passage communicates with an inlet port, and the outlet flow passage communicates with an outlet port.

### TECHNICAL FIELD

The present disclosure relates to an EGR valve system to be provided in a flow passage for EGR gas and used to regulate a flow rate of EGR gas.

### BACKGROUND ART

Conventionally, as a technique of the above type, for example, an EGR valve described in Patent document 1 listed below is known. This EGR valve is provided with a housing internally including an EGR gas passage (a valve flow passage), a valve seat provided in the valve flow passage, a valve element provided to be capable of seating on the valve seat, a valve shaft placed in the housing in a form extending through the valve flow passage and provided with the valve element, and a motor (a driving unit) for driving the valve shaft to reciprocate. The housing has a nearly cylindrical shape, provided with an inlet at one end in the axial direction and an outlet on the outer periphery of the housing. Further, the valve flow passage includes, in its middle, a bent part that bends in a direction perpendicular to the valve shaft. Specifically, the valve flow passage has a nearly L-shape, including an inlet flow passage that extends in a direction coaxial with the valve shaft and opens, and an outlet flow passage that extends in a direction perpendicular to the valve shaft and opens. This EGR valve is mounted in an EGR passage, which is a mating member, by assembling of the housing in an assembly hole provided in the EGR passage.

### RELATED ART DOCUMENTS

### Patent Documents

Patent Document 1: Japanese unexamined patent application publication No. 2015-017506

### SUMMARY OF INVENTION

### Problems to be Solved by the Invention

However, in the EGR valve described in Patent Document 1 in which the valve flow passage has a nearly L-shape, in some cases, the shape of the housing may need to be changed to meet the constraints in mounting on different vehicles. For example, depending on the shape and arrangement of the pipe of the EGR passage, the nearly-L-shaped valve flow passage may not fit the pipe. In this case, the shape of the valve flow passage must be changed, which needs machining of the housing or changing of the shape of the valve flow passage. For example, it may be necessary to make a hole in the housing for assembly of a part around the valve shaft or to block the formed hole with a plug after the part is assembled. In this case, countermeasures need against gas leakage and corrosion at the portion blocked with the plug. Furthermore, when changing the shape of the housing, it may require an assembly work between the changed housing and the driving unit, or changing the configuration of assembling the parts around the valve shaft.

The present disclosure has been made to address the above problems and has a purpose to provide an EGR valve system capable of providing an EGR valve to meet various flow passage constraints in mounting on a vehicle without changing the shape of a housing or replacing attachment parts.

### Means of Solving the Problems

(1) To achieve the above-mentioned purpose, one aspect of the present disclosure provides an EGR valve system comprising: a valve assembly; and a plurality of different housing adapters to be assembled with the valve assembly, wherein the valve assembly is provided with: a housing including a flow passage for EGR gas, the flow passage including an inlet port and an outlet port for the EGR gas; a valve seat provided in the flow passage; a valve element that is provided in the flow passage and capable of seating on the valve seat; a valve shaft on which the valve element is provided; and a driving unit for driving the valve shaft, the housing adapters each include: an assembly hole for the housing; and an inlet flow passage and an outlet flow passage each communicating with the assembly hole, and the EGR valve system is configured such that one of the plurality of different housing adapters is selectively combined with the valve assembly, the housing of the valve assembly is assembled in the assembly hole of the selected housing adapter, and, in this assembled state, the inlet flow passage communicates with the inlet port and the outlet flow passage communicates with the outlet port.

According to the foregoing configuration (1), one of the plurality of different housing adapters is selectively combined with the valve assembly. Thus, the housing of the valve assembly is assembled in the assembly hole of the selected housing adapter. In this assembled state, the inlet flow passage of the housing adapter communicates with the inlet of the flow passage of the housing and, similarly, the outlet flow passage of the housing adapter communicates with the outlet of the flow passage of the housing. Thus, the valve assembly can be used in common to each of the plurality of different housing adapters. Further, as many as the number of housing adapters, arrangements of the inlet flow passage and the outlet flow passage can be combined in various types and various kinds.

(2) To achieve the above-mentioned purpose, in the foregoing configuration (1); preferably, the plurality of different housing adapters include the assembly holes that each have a common shape matching a shape of the housing, and one of the inlet flow passages or the outlet flow passages are formed in common positions and common orientations between the different housing adapters, while the other outlet flow passages or inlet flow passages are formed in different positions and different orientations between the different housing adapters.

According to the above-described configuration (2), in addition to the operations of the configuration (1), the plurality of different housing adapters include: the assembly holes that are common with each other; the inlet or outlet flow passages formed in common positions and common orientations with each other; and the outlet or inlet flow passage formed in different positions and different orientations from each other. Thus, pipes of an FUR passage can be commonalized with respect to the inlet or outlet flow passages of the housing adapters.

(3) To achieve the above-mentioned purpose, in the foregoing configuration (2), preferably, the plurality of different housing adapters include a first housing adapter, when the housing is assembled in the assembly hole of the first housing adapter, the inlet flow passage, the flow passage, and the outlet flow passage constitute a valve flow passage continuous in a nearly L-shape, and in the valve flow passage continuous in the nearly L-shape, one of the inlet flow passage or the outlet flow passage extends and opens in an axial direction of the valve shaft, the other outlet flow passage or inlet flow passage extends and opens in a direction intersecting with the axial direction, and the flow passage connects the inlet flow passage and the outlet flow passage.

According to the above-described configuration (3), in addition to the operations of the configuration (2), an EGR valve obtained by combination of the valve assembly with the first housing adapter is configured so that the valve flow passage is continuous in a nearly L-shape. Thus, the FUR valve can be used for an arrangement that the axis of a pipe of an FUR passage connected to the inlet flow passage and the axis of a pipe of an EGR passage connected to the outlet flow passage intersect each other at almost right angle.

(4) To achieve the above-mentioned purpose, in the foregoing configuration (2), preferably, the plurality of different housing adapters include a second housing adapter, when the housing is assembled in the assembly hole of the second housing adapter, the inlet flow passage, the flow passage, and the outlet flow passage constitute a valve flow passage continuous in a nearly Z-shape or U-shape, and in the valve flow passage continuous in the nearly Z-shape or U-shape, both the inlet flow passage and the outlet flow passage extend and open in a direction intersecting with an axial direction of the valve shaft, and the flow passage connects the inlet flow passage and the outlet flow passage.

According to the above-described configuration (4), in addition to the operations of the configuration (2), an EGR valve obtained by combination of the valve assembly with the second housing adapter is configured so that the valve flow passage is continuous in a nearly Z-shape or U-shape. Thus, the EGR valve can be used for an arrangement that the axis of a pipe of an EGR passage connected to the inlet flow passage and the axis of a pipe of an EGR passage connected to the outlet flow passage are offset.

(5) To achieve the above-mentioned purpose, in one of the foregoing configurations (1) to (4), preferably, the housing is made of a resin material.

According to the above-described configuration (5), in addition to the operations of one of the foregoing configurations (1) to (4), the housing is made of a resin material and thus the housing can have corrosion resistance.

(6) To achieve the above-mentioned purpose, in the foregoing configuration (5), preferably, the housing adapter is made of a resin material.

According to the above-described configuration (6), in addition to the operations of the configuration (5), the housing adapter is made of a resin material and thus the housing adapter can have corrosion resistance.

(7) To achieve the above-mentioned purpose, in the foregoing configuration (6), preferably, the housing assembled in the assembly hole is fixed to the housing adapter by welding.

According to the above-described configuration (7), in addition to the operations of the configuration (6), the housing and the housing adapter can be integral with each other by welding.

### Effects of the Invention

According to the foregoing configuration (1), an EGR valve can be provided to meet various flow passage constraints in mounting on a vehicle without changing the shape of the housing of the valve assembly and replacing attachment parts.

According to the foregoing configuration (2), in addition to the effects of the above-described configuration (1), designing the arrangement of an EGR valve in a vehicle can be facilitated.

According to the foregoing configuration (3), in addition to the effects of the above-described configuration (2), the valve assembly can be common to a specific pipe arrangement of the EGR valve.

According to the foregoing configuration (4), in addition to the effects of the above-described configuration (2), the valve assembly can be common to a specific pipe arrangement of the EGR valve.

According to the foregoing configuration (5), in addition to the effects of one of the above-described configurations (1) to (4), it is possible to prevent corrosion of the EGR valve due to condensate water of EGR gas and thus stabilize the flow characteristics of EGR gas. Furthermore, metal parts, such as a valve seat, can be made by insert molding in the housing, so that the housing can be designed to be thin in wall thickness and small in size.

According to the foregoing configuration (6), in addition to the effects of the above-described configuration (5), it is further possible to prevent corrosion of the EGR valve due to condensate water of EGR gas and thus stabilize the flow characteristics of EGR gas.

According to the foregoing configuration (7), in addition to the effects of the above-described configuration (6), this configuration can prevent separation between the housing and the housing adapter due to deformation. Further, since the housing is applied with welding along the entire outer periphery thereof, airtightness between the housing and the housing adapter can be achieved by that welding, and thus a seal member may be dispensed with.

### BRIEF DESCRIPTION OF THE DRAWINGS

FIG. 1 is a conceptual diagram showing an EGR valve system in a first embodiment;

FIG. 2 is a perspective view of a valve assembly in the first embodiment;

FIG. 3 is a front view of a valve assembly including a partial cross-sectional view in the first embodiment;

FIG. 4 is a perspective view of a first housing adapter including a partial cross-sectional view in the first embodiment;

FIG. 5 is a perspective view of a second housing adapter in the first embodiment;

FIG. 6 is a perspective view of a third housing adapter in the first embodiment;

FIG. 7 is a perspective view of a first EGR valve including a partial cross-sectional view in the first embodiment;

FIG. 8 is a front view of the first EGR valve including a partial cross-sectional view in the first embodiment;

FIG. 9 is an exploded front view of the first EGR valve including a partial cross-sectional view in the first embodiment;

FIG. 10 is a perspective view of a second EGR valve seen from one direction in the first embodiment;

FIG. 11 is a perspective view of the second EGR valve seen from another direction in the first embodiment;

FIG. 12 is a front view of the second EGR valve in the first embodiment;

FIG. 13 is a front view of the second EGR valve including a partial cross-sectional view in the first embodiment;

FIG. 14 is an exploded front view of the second EGR valve including a partial cross-sectional view in the first embodiment;

FIG. 15 is a perspective view of a third EGR valve seen from one direction in the first embodiment;

FIG. 16 is a front view of the third EGR valve in the first embodiment;

FIG. 17 is a front view of the third EGR valve including a partial cross-sectional view in the first embodiment;

FIG. 18 is an exploded front view of the third FOR valve including; a partial cross-sectional view in the first embodiment; and

FIG. 19 is a front view of a first EGR valve including a partial cross-sectional view in a second embodiment.

### MODE FOR CARRYING OUT THE INVENTION

### First Embodiment

A detailed description of a first embodiment of an EGR valve system of this disclosure will now be given referring to the accompanying drawings.

(EGR Valve System)

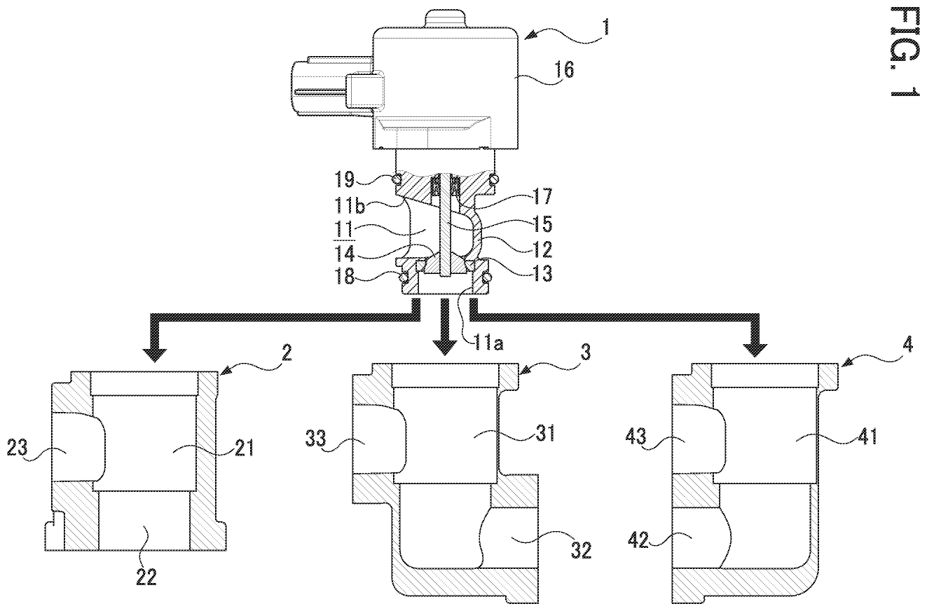

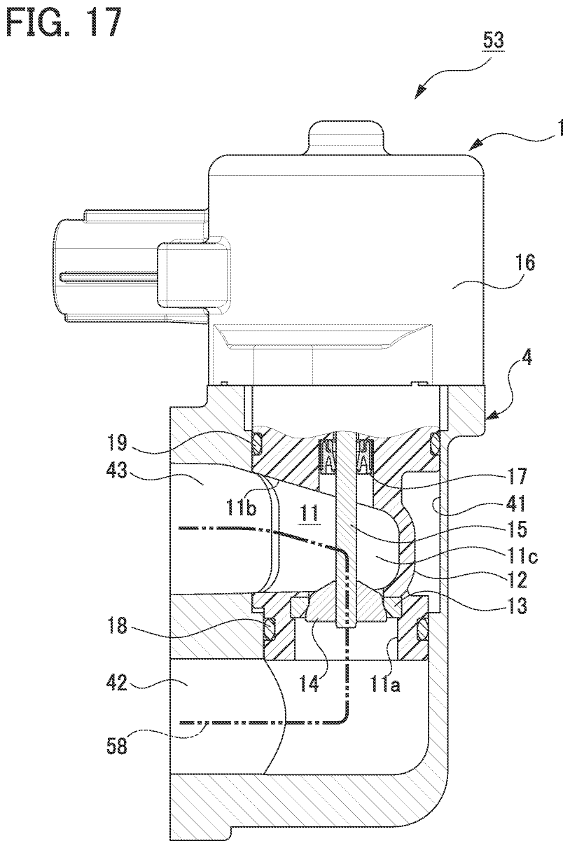

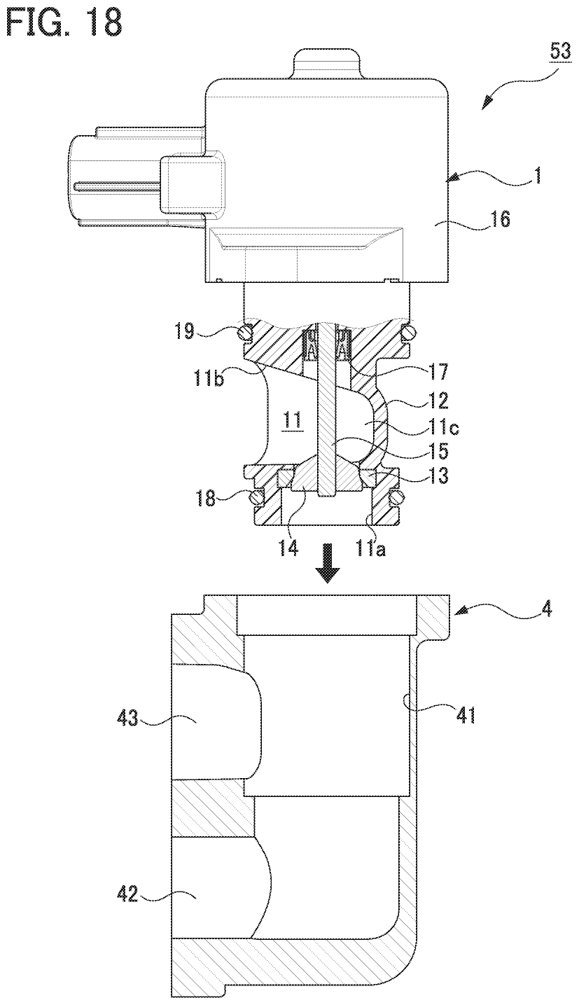

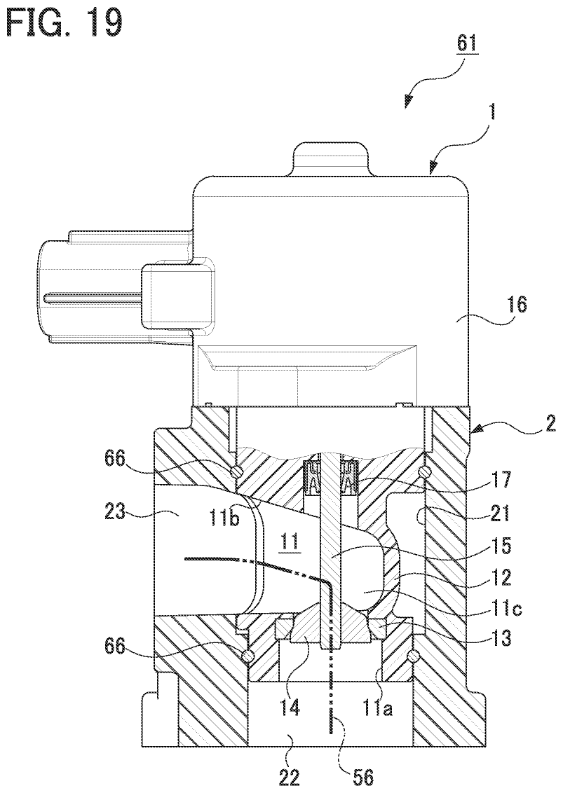

FIG. 1 is a conceptual diagram of an EGR valve system in the present embodiment. As shown in FIG. 1, this EGR valve system includes a single valve assembly 1, a plurality of different housing adapters (three in the present embodiment), namely, a first housing adapter 2, a second housing adapter 3, and a third housing adapter 4. This EGR valve system is configured such that one of the first to third housing adapters 2 to 4, which are different from each other, is selectively combined with the single valve assembly 1; and the selected one of the housing adapters 2 to 4 is assembled with the valve assembly 1, constituting one of FOR valves 51 to 53 (see FIGS. 17 and 18) which will be described later. Herein, the EGR valves 51 to 53 are provided in an EGR passage (not shown) as well known. The EGR passage is connected to an intake passage to allow part of exhaust gas discharged as EGR gas from an engine to an exhaust passage to recirculate into the engine. The EGR valves 51 to 53 are used to regulate a flow rate of EGR gas in the EGR passage.

(Valve Assembly)

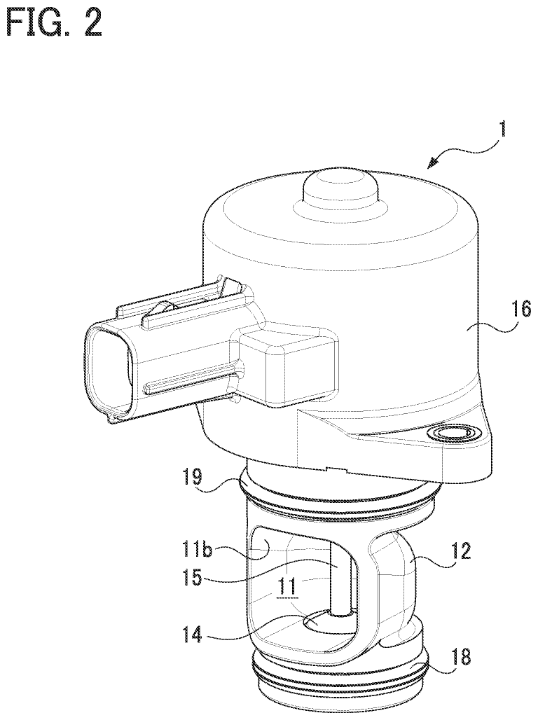

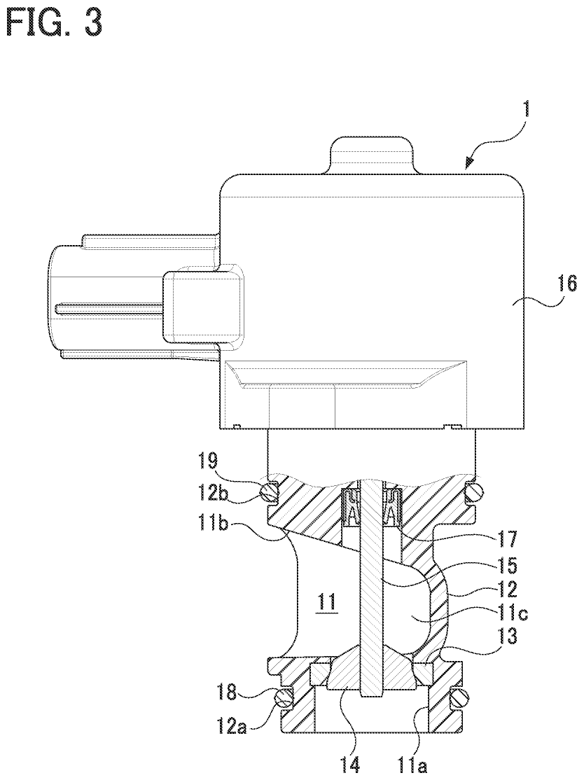

Next, the valve assembly 1 will be described below. FIG. 2 is a perspective view of the valve assembly 1. FIG. 3 is a front view of the valve assembly 1 including a partial cross-sectional view. As shown in FIGS. 1 to 3, the valve assembly 1 has a poppet valve structure and is provided with a housing 12 including a flow passage 11 for EGR gas, an annular valve seat 13 provided in the flow passage 11, a valve element 14 that has a nearly umbrella shape and is able to seat on the valve seat 13 in the flow passage 11, a valve shaft 15 on one end of which the valve element 14 is provided, and a driving unit 16 to drive the valve shaft 15 together with the valve element 14 to reciprocate. The flow passage 11 includes an inlet port 11a at one end and an outlet port 11b at the other end. The driving unit 16 can be constituted of for example a motor or a stepping motor. FIGS. 1 and 3 show cross-sections of a part of the housing 12, the valve seat 13, the valve element 14, the valve shaft 15, and others excepting the driving unit 16. The valve seat 13 is formed separately from the housing 12 and assembled in the flow passage 11. The housing 12 is made of a resin material, and the valve seat 13, valve element 14, and valve shaft 15 are made of a metal material. In the present embodiment, the valve seat 13 is provided in the housing 12 by insert molding. The shapes of the valve seat 13 and the valve element 14 are one examples. The valve assembly 1 is configured to move the valve element 14 with respect to the valve seat 13 to change an opening degree between the valve element 14 and the valve seat 13, thereby regulating a flow rate of EGR gas in the flow passage 11. In the present embodiment, the details of the driving unit 16 are omitted.

As shown in FIGS. 1 and 3, the valve shaft 15 extending downward from the driving unit 16 is inserted in the housing 12. The valve shaft 15 is placed in parallel to the axis of the valve seat 13. The valve element 14 is configured to seat on (contact with) and separate from the valve seat 13 in association with reciprocating movement of the valve shaft 15. Between the housing 12 and the valve shaft 15, a lip seal 17 is provided to seal between the housing 12 and the valve shaft 15. In the present embodiment, the valve element 14 is placed to make reciprocation at the lower (upstream) side of the valve seat 13.

In the present embodiment, the flow passage 11 includes a bent passage part 11c bending in a direction intersecting with a direction toward the inlet port 11a at an upper (downstream) side of the valve seat 13. The bent passage part 11c gradually widens in diameter toward the outlet port 11b.

In the present embodiment, the housing 12 is provided, on its outer surface, with a first sealing member 18 and a second sealing member 19. In the present embodiment, those two sealing members 18 and 19 are formed of rubber O-rings. In the present embodiment, the first sealing member 18 is placed on the outer periphery of the housing 12, near the inlet port 11a of the housing 12 and around the inlet port 11a. The housing 12 is formed, in the outer periphery near the inlet port 11a, with a peripheral groove 12a. The first sealing member 18 is mounted in this peripheral groove 12a. The second sealing member 19 is placed on the outer periphery of the housing 12, above the outlet port 11b, The housing 12 is formed, in the outer periphery above the outlet port 11b, with a peripheral groove 12b. The second sealing member 19 is mounted in this peripheral groove 12b.

(First to Third Housing Adapters)

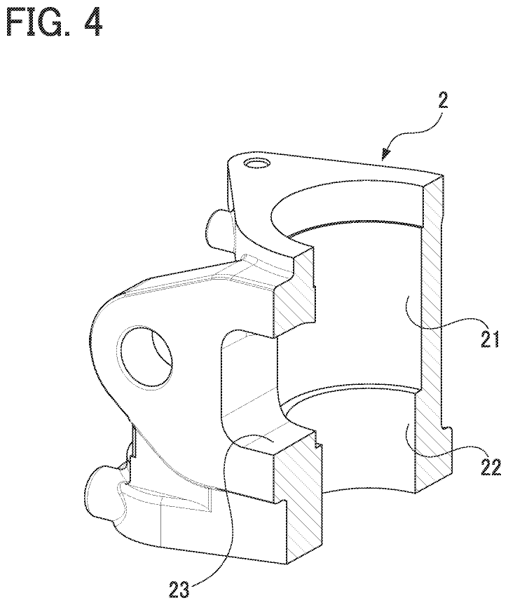

The first to third housing adapters 2 to 4 will be described below. The first housing adapter 2 is described first. FIG. 4 is a perspective view of the first housing adapter 2 including a partial cross-sectional view. As shown in FIGS. 1 and 4, the first housing adapter 2 is made of a metal material (e.g., aluminum) in a nearly, cylindrical shape and provided with an assembly hole 21 for assembly of the housing 12 of the valve assembly 1, an inlet flow passage 22 and an outlet flow passage 23 which communicate with the assembly hole 21. In the present embodiment, the assembly hole 21 is formed opening upward in FIGS. 1 and 4 and being parallel with the axis of the first housing adapter 2. The inlet flow passage 22 is coaxial with this assembly hole 21 under the assembly hole 21, and downward extends and opens. The outlet flow passage 23 extends and opens, sideways from this assembly hole 21, in a direction intersecting with the axis of the assembly hole 21.

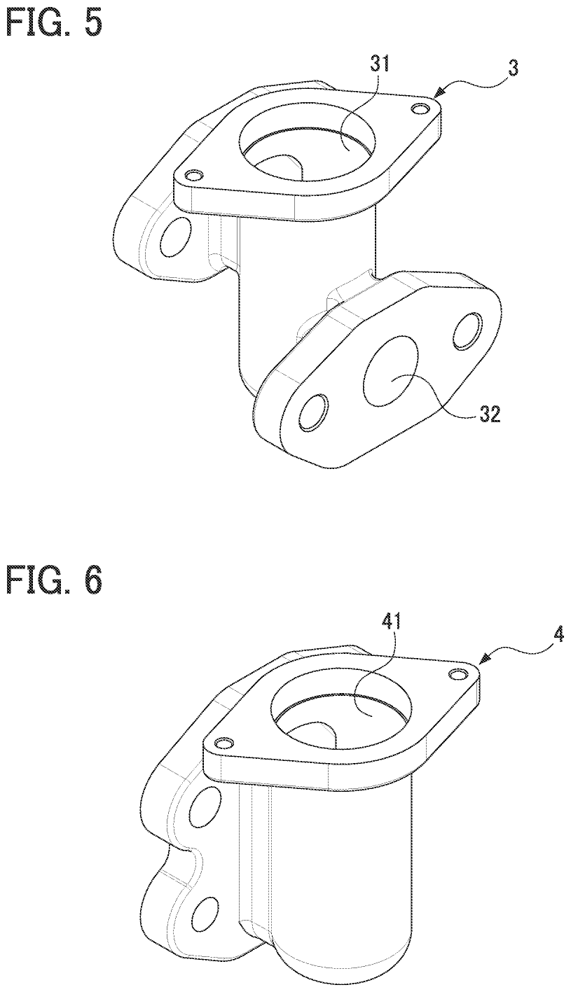

The second housing adapter 3 is described below. FIG. 5 is a perspective view of the second housing adapter 3. As shown in FIGS. 1 and 5, the second housing adapter 3 is made of a metal material (e.g., aluminum) in a bottom-closed nearly cylindrical shape and is provided with an assembly hole 31 for assembly of the housing 12 of the valve assembly 1, an inlet flow passage 32 and an outlet flow passage 33 which communicate with the assembly hole 31. In the present embodiment, the assembly hole 31 is formed to open upward in FIGS. 1 and 5, and extend in parallel with the axis of the second housing adapter 3. The inlet flow passage 32 extends downward along the assembly hole 31, under the assembly hole 31, and further extends bending in a direction intersecting with the axis and opens. The outlet flow passage 33 extends and opens, sideways from the assembly hole 31, in a direction intersecting with the axis of the assembly hole 31, that is, an opposite direction to the inlet flow passage 32. The outlet flow passage 33 is located above the inlet flow passage 32.

The third housing adapter 4 is described below. FIG. 6 is a perspective view of the third housing adapter 4. As shown in FIGS. 1 and 6, the third housing adapter 4 is made of a metal material (e.g., aluminum) in a bottom-closed nearly cylindrical shape and is provided with an assembly hole 41 for assembly of the housing 12 of the valve assembly 1, an inlet flow passage 42 and an outlet flow passage 43 which communicate with the assembly hole 41. In the present embodiment, the assembly hole 41 is formed to open upward in FIGS. 1 and 6, and extends in parallel with the axis of the third housing adapter 4. The inlet flow passage 42 extends downward along the axis of the assembly hole 41, under the assembly hole 41, and further extends bending and opening in a direction intersecting with the axis. The outlet flow passage 43 extends and opens, sideways from this assembly hole 41, in a direction intersecting with the axis of the assembly hole 41, that is, in the same direction as the inlet flow passage 42. The outlet flow passage 43 is placed above the inlet flow passage 42.

In the present embodiment, as shown in FIG. 1, three different, first to third housing adapters 2 to 4 respectively include the assembly holes 21, 31, and 41 that each have a common shape matching the shape of the housing 12 of the valve assembly 1. In the present embodiment, among the first to third housing adapters 2 to 4 respectively including the inlet flow passages 22, 32, and 42 and the outlet flow passages 23, 33, and 43, the outlet flow passages 23, 33, and 43 are formed in common positions, common orientations, and common shapes with each other. In contrast, among the first to third housing adapters 2 to 4, the inlet flow passages 22, 32, and 42 are formed in different positions and different orientations from each other. In the present embodiment, the inlet flow passage 32 and the inlet flow passage 42 have the same shape.

(First to Third EGR Valves)

In the present embodiment, one of three different, first to third housing adapters 2 to 4 is selectively combined with the valve assembly 1, and thus the housing 12 of the valve assembly 1 is assembled in the assembly hole 21, 31, or 41 of the selected one of the first to third housing adapters 2 to 4. In this assembled state, the inlet flow passage 22, 32, or 42 communicates with the inlet port 11a of the housing 12, while the outlet flow passage 23, 33, or 43 communicates with the outlet port 11b of the housing 12. Thus, a first EGR valve 51, a second EGR valve 52, or a third EGR valve 53, which will be described later, is selectively constituted.

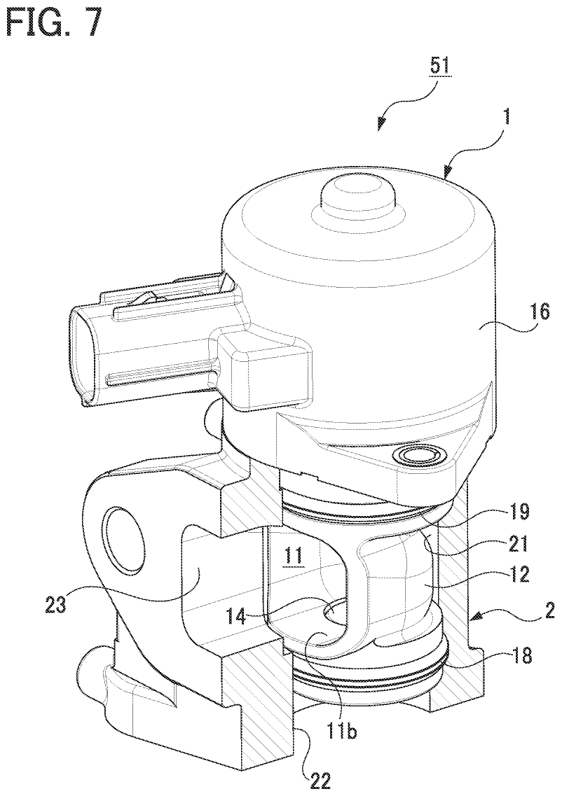

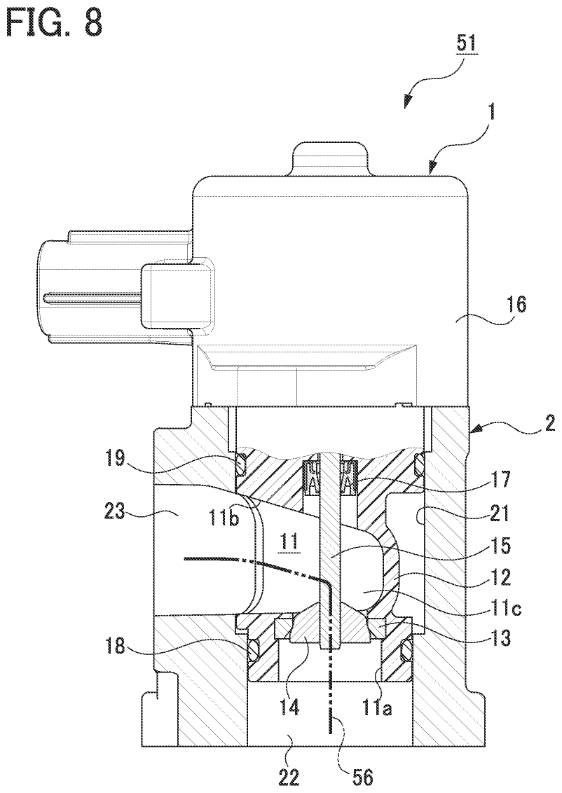

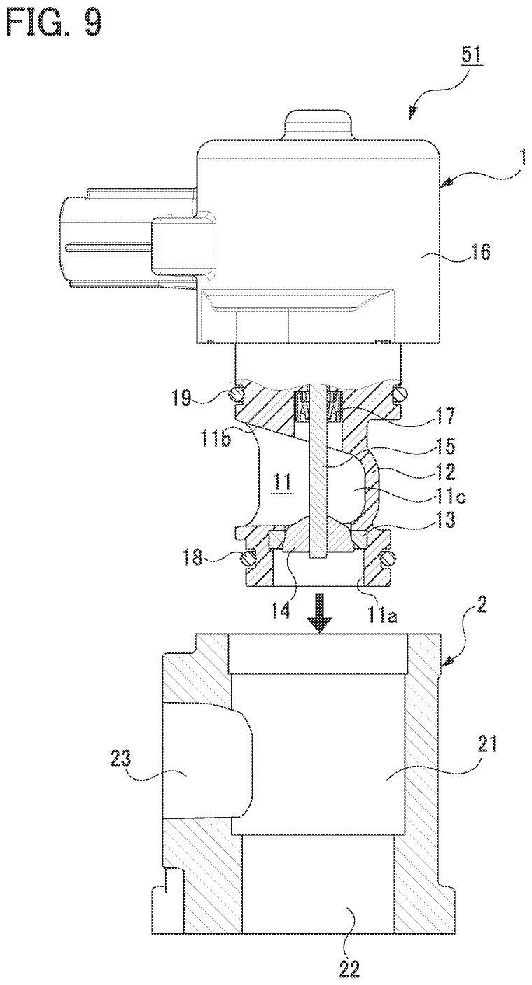

The first EGR valve 51 is first described. FIG. 7 is a perspective view of the first EGR valve 51 including a partial cross-sectional view. FIG. 8 is a front view of the first EGR valve 51 including a partial cross-sectional view. FIG. 9 is an exploded front view of the first EGR valve 51 including a partial cross-sectional view. As shown in FIGS. 7 to 9, the first EGR valve 51 includes the first housing adapter 2. While the housing 12 is assembled in the assembly hole 21 of the first housing adapter 2, the inlet flow passage the flow passage 11, and the outlet flow passage 23 constitute a first valve flow passage 56 that is continuous in a nearly L-shape (a nearly inverted L-shape) as indicated with a dashed-double-dotted line in FIG. 8. The first valve flow passage 56 continuous in the nearly L-shape is configured such that the inlet flow passage 22 extends and opens in the axial direction (in a downward direction in FIG. 8) of the valve shaft 15, the outlet flow passage 23 extends and opens in a direction (a horizontal direction in FIG. 8) intersecting with the axial direction of the valve shaft 15, and the flow passage 11 connects the inlet flow passage 22 and the outlet flow passage 23.

To produce the first EGR valve 51 in the present embodiment, as shown in FIG. 9, the valve assembly 1 which is obtained in advance by assembling together the driving unit 16 (including the valve shaft 15 and others), the housing 12, the valve seat 13, the valve element 14, the first sealing member 18, and the second sealing member 19 is assembled in the first housing adapter 2. Specifically, the housing 12 of the valve assembly 1 is inserted in (dropped in) the assembly hole 21 of the first housing adapter 2. At that time, the housing 12 and the first housing adapter 2 are positioned so that the inlet port 11a of the flow passage 11 and the inlet flow passage 22 communicate with each other and the outlet port 11b of the flow passage 11 and the outlet flow passage 23 communicate with each other. Thus, one first EGR valve 51 as shown in FIGS. 7 and 8 is obtained.

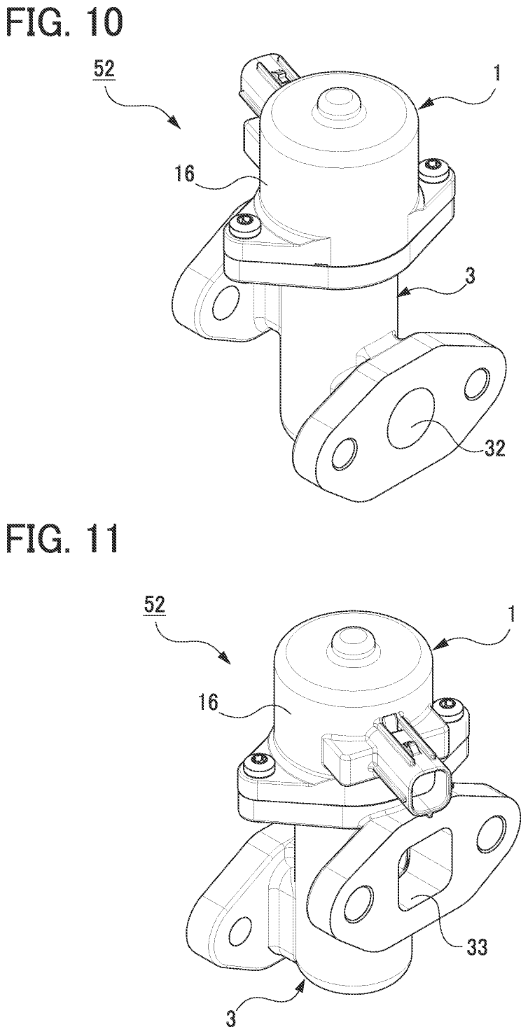

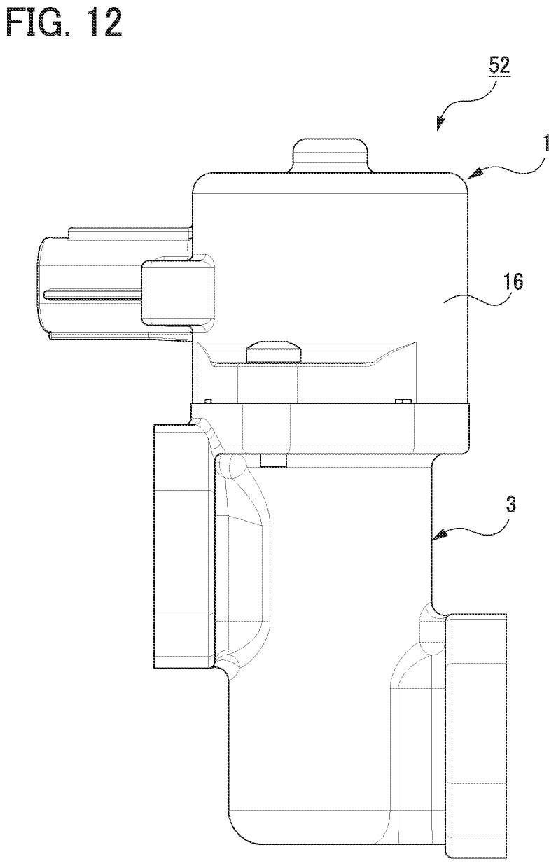

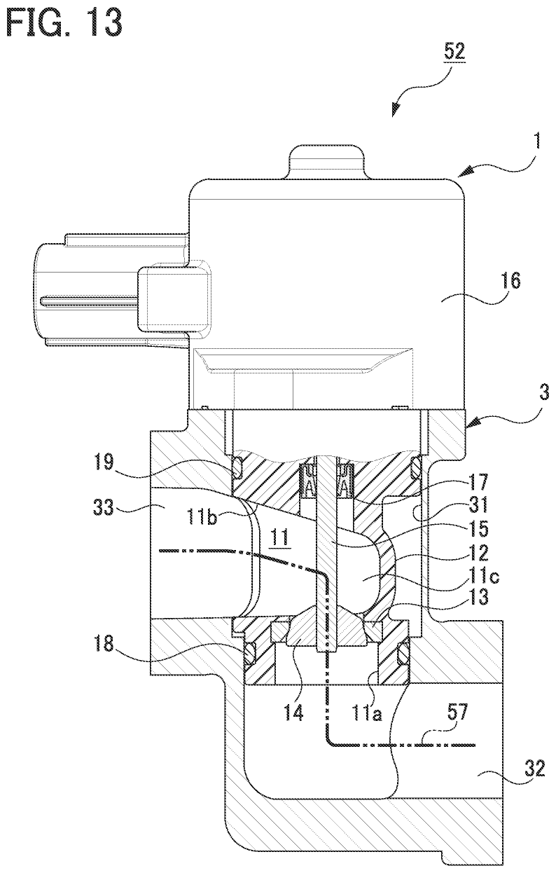

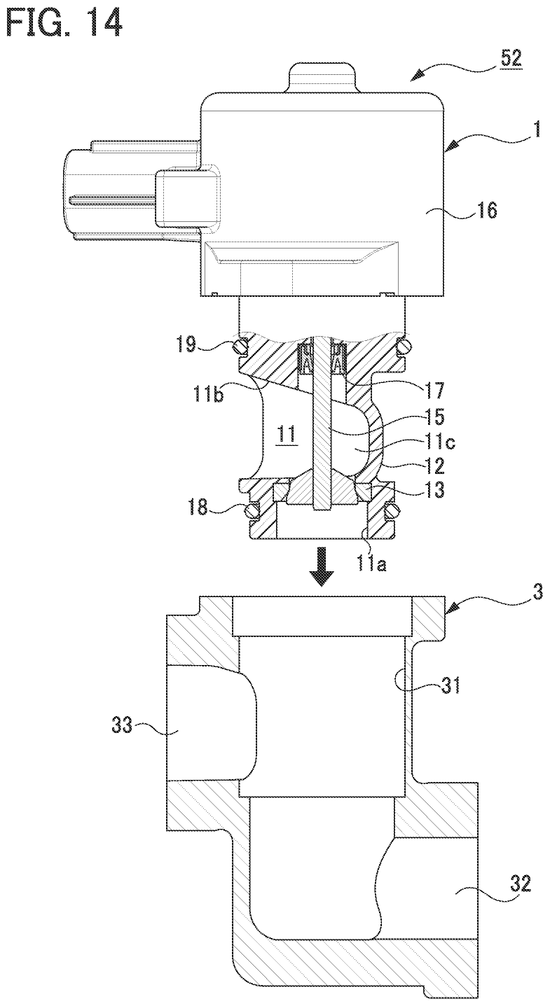

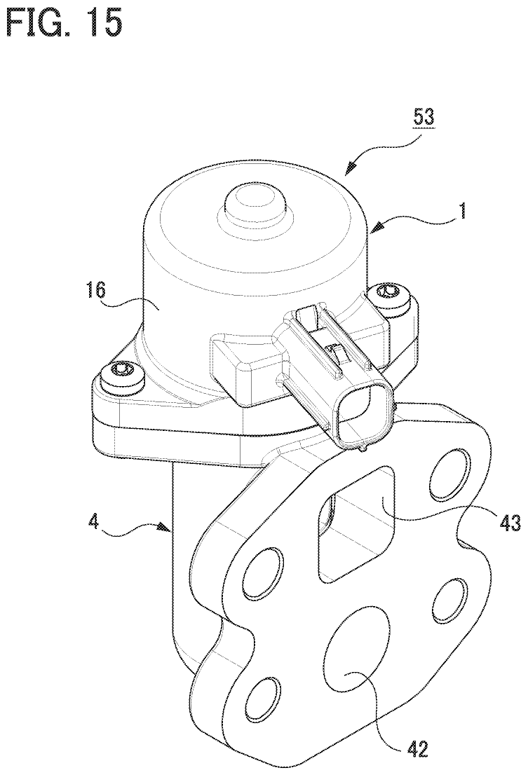

The second EGR valve 52 is described below. FIG. 10 is a perspective view of the second EGR valve 52 seen from one direction. FIG. 11 is a perspective view of the second EGR valve 52 seen from another direction. FIG. 12 is a front view of the second EGR valve 52. FIG. 13 is a front view of the second EGR valve 52 including a partial cross-sectional view. FIG. 14 is an exploded front view of the second EGR valve 52 including a partial cross-sectional view. As shown in FIGS. 10 to 14, the second EGR valve 52 includes the second housing adapter 3. While the housing 12 is assembled in the assembly hole 31 of the second housing adapter 3, the inlet flow passage 32, the flow passage 11, and the outlet flow passage 33 constitute a second valve flow passage 57 continuous in a nearly Z-shape as indicated with a dashed-double-dotted line in FIG. 13. The second valve flow passage 57 continuous in a nearly Z-shape is configured such that both the inlet flow passage 32 and the outlet flow passage 33 extend and opens in a direction (a horizontal direction in FIG. 13) intersecting with the axial direction of the valve shaft 15 and in opposite directions to each other, and the flow passage 11 connects the inlet flow passage 32 and the outlet flow passage 33.

To produce the second EGR valve 52 in the present embodiment, as shown in FIG. 14, the valve assembly 1 assembled in advance is assembled in the second housing adapter 3. Specifically, the housing 12 of the valve assembly 1 is inserted in (dropped in) the assembly hole 31 of the second housing adapter 3. At that time, the housing 12 and the second housing adapter 3 are positioned so that the inlet port 11a of the flow passage 11 and the inlet flow passage 32 communicate with each other and the outlet port 11b of the flow passage 11 and the outlet flow passage 33 communicate with each other. Thus, one second EGR valve 52 as shown in FIGS. 10 to 13 is obtained.

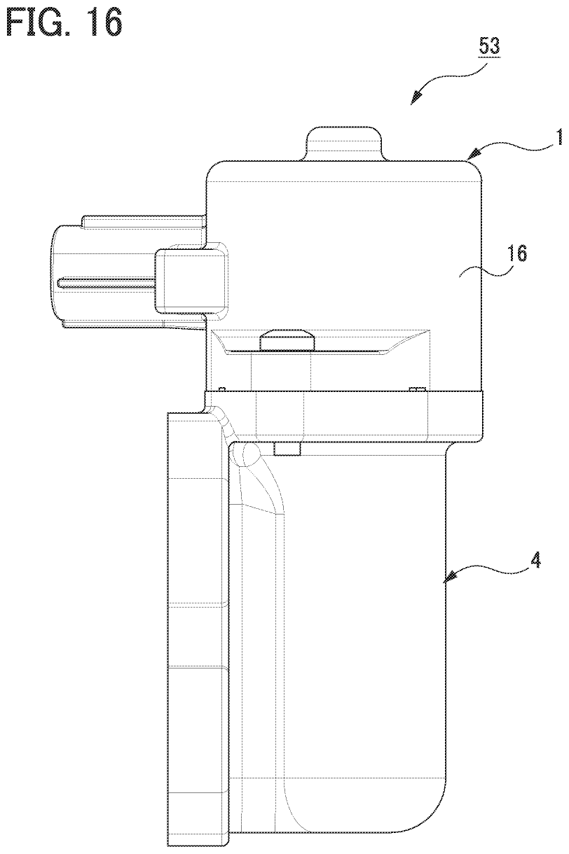

The third EGR valve 53 is further described below. FIG. 15 is a perspective view of the third EGR valve 53 seen from one direction. FIG. 16 is a front view of the third EGR valve 53. FIG. 17 is a front view of the third EGR valve 53 including a partial cross-sectional view. FIG. 18 is an exploded front view of the third EGR valve 53 including a partial cross-sectional view. As shown in FIGS. 1.5 to 18, the third FUR valve 53 includes the third housing adapter 4. While the housing 12 is assembled in the assembly hole 41 of the third housing adapter 4, the inlet flow passage 42, the flow passage 11, and the outlet flow passage 43 constitute a third valve flow passage 58 continuous in a nearly U-shape as indicated with a dashed-double-dotted line in FIG. 17. The third valve flow passage 58 continuous in the nearly U-shape is configured such that both the inlet flow passage 42 and the outlet flow passage 43 extend and open in a direction (a horizontal direction in FIG. 17) intersecting the axial direction of the valve shaft 15 and in the same direction as each other, and the flow passage 11 connects the inlet flow passage 42 and the outlet flow passage 43.

To produce the third EGR valve 53 in the present embodiment, as shown in FIG. 18, the valve assembly 1 assembled in advance is assembled in the third housing adapter 4. Specifically, the housing 12 of the valve assembly 1 is inserted in (dropped in) the assembly hole 41 of the third housing adapter 4. At that time, the housing 12 and the third housing adapter 4 are positioned so that the inlet port 11a of the flow passage 11 and the inlet flow passage 42 communicate with each other and the outlet port 11b of the flow passage 11 and the outlet flow passage 43 communicate with each other. Thus, one third EGR valve 53 as shown in FIGS. 15 to 17 is obtained.

(Operations and Effects of the EGR Valve System)

According to the configuration of the EGR valve system in the present embodiment described above, one of the three different, first to third housing adapters 2 to 4 is selectively combined with a single valve assembly 1. Thus, the housing 12 of the valve assembly 1 is assembled in the assembly hole 21, 31, or 41 of the selected one of the first to third housing adapters 2 to 4. In this assembled state, the inlet flow passage 22, 32, or 42 of the selected one of the housing adapters 2 to 4 communicates with the inlet port 11a of the flow passage 11 of the housing 12 and, similarly, the outlet flow passage 23, 33, or 43 of the selected one of the housing adapters 2 to 4 communicates with the outlet port 11b of the flow passage 11. Thus, the valve assembly 1 can be used in common to the three different, first to third housing adapters 2 to 4. Further, as many as the number of first housing adapters 2 to 4, arrangements of the inlet flow passages 22, 32, and 42 and the outlet flow passages 23, 33, and 43 can be combined in various types and various kinds. Consequently, the first to third EGR valves 51 to 53 can be provided to meet various flow passage constrains in mounting on a vehicle without changing the shape of the housing 12 of the valve assembly 1 and replacing attachment parts. Moreover, the shapes of the first to third housing adapters 2 to 4 can be relatively simplified and the space required to mount the EGR valve in a vehicle can be saved just by that much.

According to the configuration in the present embodiment, the three different, first to third housing adapters 2 to 4 are respectively provided with the assembly holes 21, 31, 41 which are common with each other, the inlet flow passages 22, 32, 42 or outlet flow passage 23, 33, 43 formed in common positions and common orientations with each other, and the outlet flow passages 23 33, 43 or inlet flow passages 22, 32, 42 formed in different positions and different orientations from each other. Accordingly, pipes of the EGR passage can be commonalized with respect to the inlet flow passages 22, 32, 42 or outlet flow passage 23, 33, 43 of the first to third housing adapters 2 to 4, This configuration can facilitate designing of the arrangement of the EGR valves 51 to 53 in a vehicle.

According to the configuration in the present embodiment, the first EGR valve 51 obtained by combination of the first housing adapter 2 with the valve assembly 1 is configured to have the first valve flow passage 56 continuous in a nearly L-shape. Thus, the first EGR valve 51 can be used for the arrangement that the axis of the pipe of the EGR passage connected to the inlet flow passage 22 and the axis of the pipe of the EGR passage connected to the outlet flow passage 23 intersect with each other at almost right angle, Consequently, the valve assembly 1 can be common to the foregoing specific pipe arrangement of the EGR passage.

According to the configuration in the present embodiment, the second EGR valve 52 obtained by combination of the second housing adapter 3 with the valve assembly 1 is configured to have the second valve flow passage 57 continuous in a nearly Z-shape. Thus, the second EGR valve 52 can be used for the arrangement that the axis of the pipe of the EGR passage connected to the inlet flow passage 32 and the axis of the pipe of the EGR passage connected to the outlet flow passage 33 are offset and extend in different directions. Consequently, the valve assembly 1 can be common to the foregoing specific pipe arrangement of the EGR passage.

According to the configuration in the present embodiment, the third EGR valve 53 obtained by combination of the third housing adapter 4 with the valve assembly 1 is configured to have the third valve flow passage 58 continuous in a nearly U-shape. Thus; the third EGR valve 53 can be used for the arrangement that the axis of the pipe of the EGR passage connected to the inlet flow passage 42 and the axis of the pipe of the EGR passage connected to the outlet flow passage 43 are offset and extend in the same direction. Consequently, the valve assembly 1 can be common to the foregoing specific pipe arrangement of the EGR passage.

According to the configuration in the present embodiment, the housing 12 of the valve assembly 1 is made of resin and thus the housing 12 can have corrosion resistance. Accordingly, the first to third EGR valves 51 to 53 can be prevented from corrosion due to condensate water of EGR gas and hence stabilize the flow characteristics of EGR gas. Moreover, the metal parts, such as the valve seat 13, can be made by insert molding in the housing 12, so that the housing 12 can be designed to be thin in wall thickness and small in size.

### Second Embodiment

Next, a second embodiment embodying the EGR valve system 11 be described in detail referring to the drawings. In the following description, the identical or equivalent components as in the first embodiment are assigned the same reference signs and dispensed with the details. The following description is given with a focus on differences from the first embodiment.

(First to Third EGR Valves)

FIG. 19 is a front view of a first EGR valve 61 including a partial cross-sectional view, in the present embodiment. The first housing adapter 2 in the present embodiment is made of a resin material. Although the details of the second and third EGR valves are omitted herein, the second and third housing adapters are also made of a resin material. In the present embodiment, the first housing adapter 2 is selected and combined with the valve assembly 1, constituting a first EGR valve 61. In the present embodiment, furthermore, as shown in FIG. 19, the housing 12 assembled in the assembly hole 21 of the first housing adapter 2 is fixed to the first housing adapter 2 by vibration welding 66. This vibration welding 66 is applied over the entire periphery of the housing 12.

(Operations and Effects of the EGR Valve System)

According to the EGR valve system in the present embodiment described above, in addition to the operations and effects in the first embodiment, the following operations and effects can be obtained. In the present embodiment, specifically, the first housing adapter 2, and the second and third housing adapters are made of a resin material, so that the first housing adapter 2 and the second and third housing adapters can have corrosion resistance. Accordingly, the first EGR valve 61 and the second and third EGR valves can be prevented from corrosion due to condensate water of EGR gas and hence stabilize the flow characteristics of EGR gas.

According to the configuration in the present embodiment, the housing 12 of the valve assembly 1 can be made integral with the first housing adapter 2, the second housing adapter, or the third housing adapter, by vibration welding 66. This makes it possible to prevent separation between the housing 12 and the first housing adapter 2 due to deformation. Further, since the housing 12 is applied with vibration welding 66 along the entire outer periphery thereof, airtightness between the housing 12 and the first housing adapter 2 can be achieved by that vibration welding 66. Thus, the first sealing member 18 and the second sealing member 19 may be dispensed with.

The present disclosure is not limited to each of the foregoing embodiments and may be partial embodied in other specific forms without departing from the essential characteristics thereof.

Each of the foregoing embodiments shows three housing adapters 2 to 4 as a plurality of different housing adapters. However, the number of the housing adapters is not limited to three, and two or four or more different housing adapters may be provided.

### INDUSTRIAL APPLICABILITY

The present disclosure is applicable to an EGR valve of an EGR apparatus to be mounted in a vehicle and others.

### REFERENCE SIGNS LIST

1 Valve assembly
2 First housing adapter
3 Second housing adapter
4 Third housing adapter
11 Flow passage
11a Inlet port
11b Outlet port
12 Housing
15 Valve seat
14 Valve element
15 Valve shaft
16 Drive unit
21 Assembly hole
27 Inlet flow passage
23 Outlet flow passage
31 Assembly hole
32 Inlet flow passage
33 Outlet flow passage
41 Assembly hole
42 Inlet flow passage
43 Outlet flow passage
51 First EGR valve
52 Second. EGR valve
53 Third EGR valve
56 First valve flow passage
57 Second valve flow passage
58 Third valve flow passage
61 First EGR valve
66 Vibration welding

1. An EGR valve system comprising:
a valve assembly; and
a plurality of different housing adapters to be assembled with the valve assembly,
wherein the valve assembly is provided with:
a housing including a flow passage for EGR gas, the flow passage including an inlet port and an outlet port for the EGR gas;
a valve seat provided in the flow passage;
a valve element that is provided in the flow passage and capable of seating on the valve seat;
a valve shaft on which the valve element is provided; and
a driving unit for driving the valve shaft,
the housing adapters each include:
an assembly hole for the housing; and
an inlet flow passage and an outlet flow passage each communicating with the assembly hole, and
the EGR valve system is configured such that one of the plurality of different housing adapters is selectively combined with the valve assembly, the housing of the valve assembly is assembled in the assembly hole of the selected housing adapter, and, in this assembled state, the inlet flow passage communicates with the inlet and port the outlet flow passage communicates with the outlet port.

2. The EGR valve system according to claim 1, wherein
the plurality of different housing adapters include the assembly holes that each have a common shape matching a shape of the housing, and
one of the inlet flow passages or the outlet flow passages are formed in common positions and common orientations between the different housing adapters, while the other outlet flow passages or inlet flow passages are formed in different positions and different orientations between the different housing adapters.

3. The EGR valve system according to claim 2, wherein
the plurality of different housing adapters include a first housing adapter,
when the housing is assembled in the assembly hole of the first housing adapter, the inlet flow passage, the flow passage, and the outlet flow passage constitute a valve flow passage continuous in a nearly L-shape, and
in the valve flow passage continuous in the nearly L-shape, one of the inlet flow passage or the outlet flow passage extends and opens in an axial direction of the valve shaft, the other outlet flow passage or inlet flow passage extends and opens in a direction intersecting with the axial direction, and the flow passage connects the inlet flow passage and the outlet flow passage.

4. The EGR valve system according to claim 2, wherein
the plurality of different housing adapters include a second housing adapter,
when the housing is assembled in the assembly hole of the second housing adapter, the inlet flow passage, the flow passage, and the outlet flow passage constitute a valve flow passage continuous in a nearly Z-shape or U-shape, and
in the valve flow passage continuous in the nearly Z-shape or U-shape, both the inlet flow passage and the outlet flow passage extend and open in a direction intersecting with an axial direction of the valve shaft, and the flow passage connects the inlet flow passage and the outlet flow passage.

5. The EGR valve system according to claim 1, wherein the housing is made of a resin material.

6. The EGR valve system according to claim 5, wherein the housing adapter is made of a resin material.

7. The EGR valve system according to claim 6, wherein the housing assembled in the assembly hole is fixed to the housing adapter by welding.

8. The EGR valve system according to claim 2, wherein the housing is made of a resin material.

9. The EGR valve system according to claim 3, wherein the housing is made of a resin material.

10. The EGR valve system according to claim 4, wherein the housing is made of a resin material.

11. The EGR valve system according to claim 8, wherein the housing adapter is made of a resin material.

12. The EGR valve system according to claim 9, wherein the housing adapter is made of a resin material.

13. The EGR valve system according to claim 10, wherein the housing adapter is made of a resin material.

14. The EGR valve system according to claim 11, wherein the housing assembled in the assembly hole is fixed to the housing adapter by welding.

15. The EGR valve system according to claim 12, wherein the housing assembled in the assembly hole is fixed to the housing adapter by welding.

16. The EGR valve system according to claim 13, wherein the housing assembled in the assembly hole is fixed to the housing adapter by welding.
